(19) United States
(12) Patent Application Publication
(10) Pub. No.: US 2011/0232887 A1
(43) Pub. Date: Sep. 29, 2011

(54) COLD PLATE WITH INTEGRAL STRUCTURAL FLUID PORT

(76) Inventors: Mark A. Zaffetti, Suffield, CT (US); Natalia Chabebe, Windsor Locks, CT (US); Michael B. Laurin, South Hadley, MA (US); Edmund P. Taddey, West Springfield, MA (US)

(21) Appl. No.: 12/748,495

(22) Filed: Mar. 29, 2010

(51) Int. Cl. F28F 7/00; B23P 15/26

(52) U.S. Cl. 165/185; 29/890.039

(57) ABSTRACT

A cold plate assembly includes a sheet having an aperture. A fluid port includes a body having a passage. A flange extends from the body and is secured to the sheet with a material. The passage and the aperture is in fluid communication with one another. The cold plate is manufactured, for example, by arranging multiple sheets relative to one another with a first material provided between the sheets. A fluid port is arranged on one of the multiple sheets with the passage in the fluid port in fluid communication with the aperture in at least one of the multiple sheets. A second material is provided between the fluid port and at least one of the multiple sheets. The fluid port and the multiple sheets are secured to one another with the first and second materials by a method, such as brazing.

### STATEMENT REGARDING FEDERALLY SPONSORED RESEARCH OR DEVELOPMENT

The subject of this disclosure was made with government support under Contract No. NNJ06TA25C, awarded by National Aeronautics and Space Administration. The government therefore may have certain rights in the claimed subject matter.

### BACKGROUND

This disclosure relates to a cold plate used, for example, in cooling electronics or avionics.

In cold plate designs, the cooling fluid is typically routed to the cold plate via system level tubing. A heat generating device for which cooling is desired is mounted to the cold plate, which removes heat from the heat generating device. The cold plate includes multiple sheets secured to one another, typically by a brazing material. Passages are provided in the cold plate for carrying a cooling fluid. The cold plate includes one or more fluid ports secured to a top sheet, for example, to fluidly communicate fluid between the system level tubing to the cold plate.

In some cases, to reduce the potential for leakage between the system level tubing and the fluid ports, couplings are not used but instead the system level tubing is welded directly to the fluid ports. A system level tube and fluid port must sometimes be cut from one another if the welded joint does not meet the inspection requirements. For aluminum cold plates, the fluid port is welded to the cold plate.

### SUMMARY

A cold plate assembly includes a sheet having an aperture. A fluid port includes a body having a passage. A flange extends from the body and is secured to the sheet with a material. The passage and the aperture are in fluid communication with one another. In one example, components are aluminum and the material is a braze material.

The cold plate described above is manufactured, for example, by arranging multiple sheets relative to one another with a first material provided between the sheets. A fluid port is arranged on one of the multiple sheets with the passage in the fluid port in fluid communication with the aperture in at least one of the multiple sheets. A second material is provided between the fluid port and at least one of the multiple sheets. The fluid port and the multiple sheets are secured to one another with the first and second materials by a method, such as brazing.

### BRIEF DESCRIPTION OF THE DRAWINGS

The disclosure can be further understood by reference to the following detailed description when considered in connection with the accompanying drawings wherein:

FIG. 1 is a schematic, exploded view of a cold plate assembly and a structural assembly.

FIG. 2 is a perspective view of an example cold plate assembly.

FIG. 3 is a side elevational view of the cold plate assembly shown in FIG. 2.

FIGS. 4A-4B are respectively perspective and cross-sectional views of one example fluid port.

FIGS. 5A-5C are respectively perspective, cross-sectional and end views of another example fluid port.

FIG. 6 is a partial cross-sectional view of the cold plate assembly shown in FIG. 2.

### DETAILED DESCRIPTION

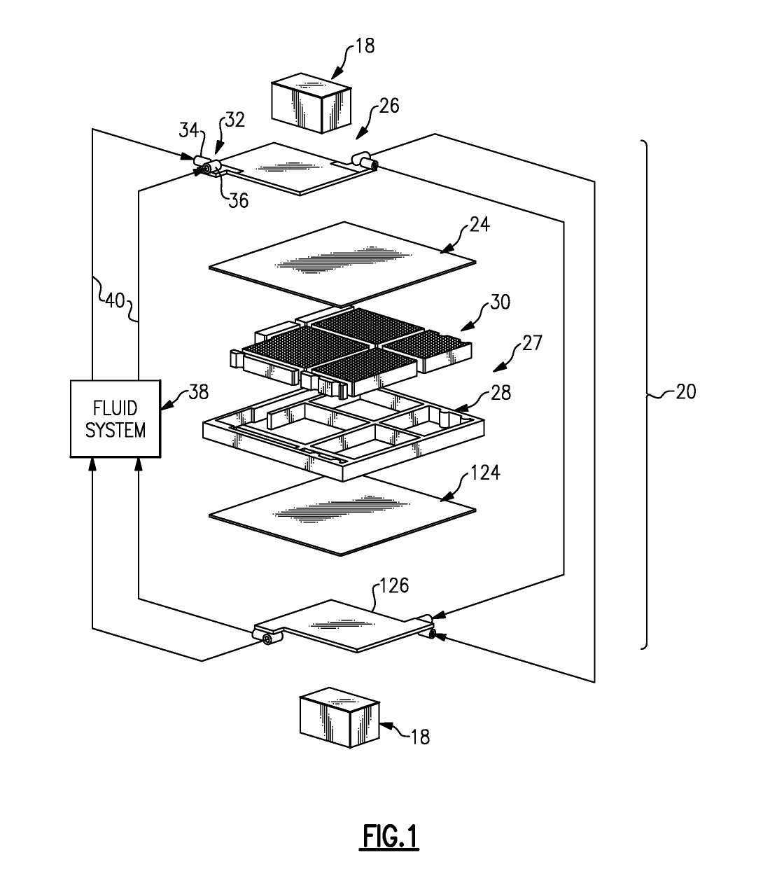

FIG. 1 schematically illustrates a structural cold plate assembly 20. The cold plate assembly 20 generally includes a first face sheet 24 with a first cold plate 26 and a second face sheet 124 with a second cold plate 126. The first face sheet 24 and the second face sheet 124 are mounted on opposing sides of a structure 27, such as a frame 28 and a honeycomb core 30, using an adhesive, for example. It should be understood that either or both of face sheets 24, 124 may be a portion of any structure inclusive of a heat generating device 18, such as electronics or avionics.

A header assembly 32, which includes a first port 34 and a second port 36, for example, communicates fluid through the cold plate 26. The first and second ports 34, 36 may be aluminum, for example. The header assembly 32 communicates with a fluid system 38 via system level tubing 40, as generally understood.

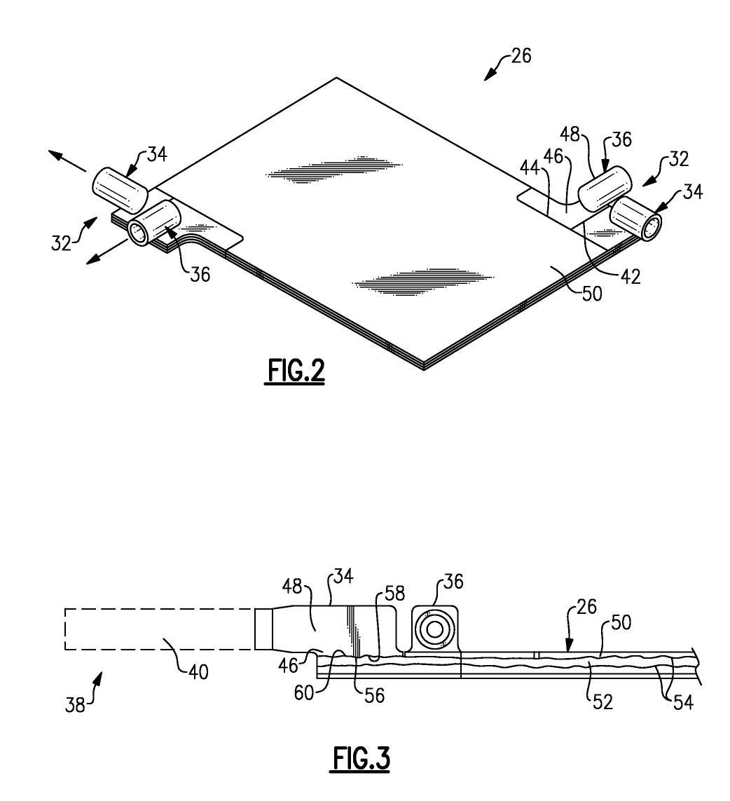

Referring to FIGS. 3 and 6, the cold plate 26 generally includes a first sheet 50, a second sheet 52, amongst other components, secured together by a first material 54, which is a brazing material in one example. The sheets 50 and 52 of the cold plate 26 are arranged to provide an internal cold plate passage 72 (FIG. 6).

In one example embodiment, the first sheet 50 may be manufactured of 3004 aluminum with a nominal thickness of 0.04 inches (1 mm), the first material 54 may be manufactured of a braze material, such as CT-23, or a Multiclad alloy with a nominal thickness of 0.016 inches (0.4 mm), and the second sheet 52 may be manufactured of 6951 aluminum with a nominal thickness of 0.05 inches (1.3 mm). It should be understood that various materials and nominal thickness may alternatively be utilized. The first material 54 may include a braze alloy that melts during a brazing process that forms an integral assembly between the first and second sheets 50, 52. It should be understood that other bonding or assembly methods may alternatively or additionally be utilized.

Referring to FIGS. 2 and 3, the cold plate 26 is illustrated in more detail. In the example shown, the first and second fluid ports 34, 36 are arranged on opposite corners of the cold plate 26. It should be understood, however, that the fluid ports 34, 36 may be arranged in any suitable location. A system level tubing 40 (FIG. 3) is secured to each of the fluid ports, typically by welding. Returning to FIG. 2, the fluid ports 34, 36 include one or more locating features that are used to locate the fluid ports 34, 36 relative to the cold plate 26 during manufacturing. In one example, the fluid port 34 includes a flange 46 having a periphery 42. The periphery 42 abuts an edge 44 of the first sheet 50. The edge 44 and at least a portion of the periphery 42 are of a complementary shape to one another such that the periphery 42 and edge 44 laterally locate the fluid port 34 relative to the cold plate 26.

As discussed above, the first and second sheets 50, 52 of the cold plate 26 are secured to one another using a first material 54, which in one example is a brazing material. A second material 56 is provided between a flange surface 58 of the flange 46 and a sheet surface 60 of the second sheet 52. In one example, the second material 56 is a brazing material, which may be the same as the first material 54. The relatively large planar area of the flange and sheet surfaces 58, 60 provides good bonding and structural integrity.

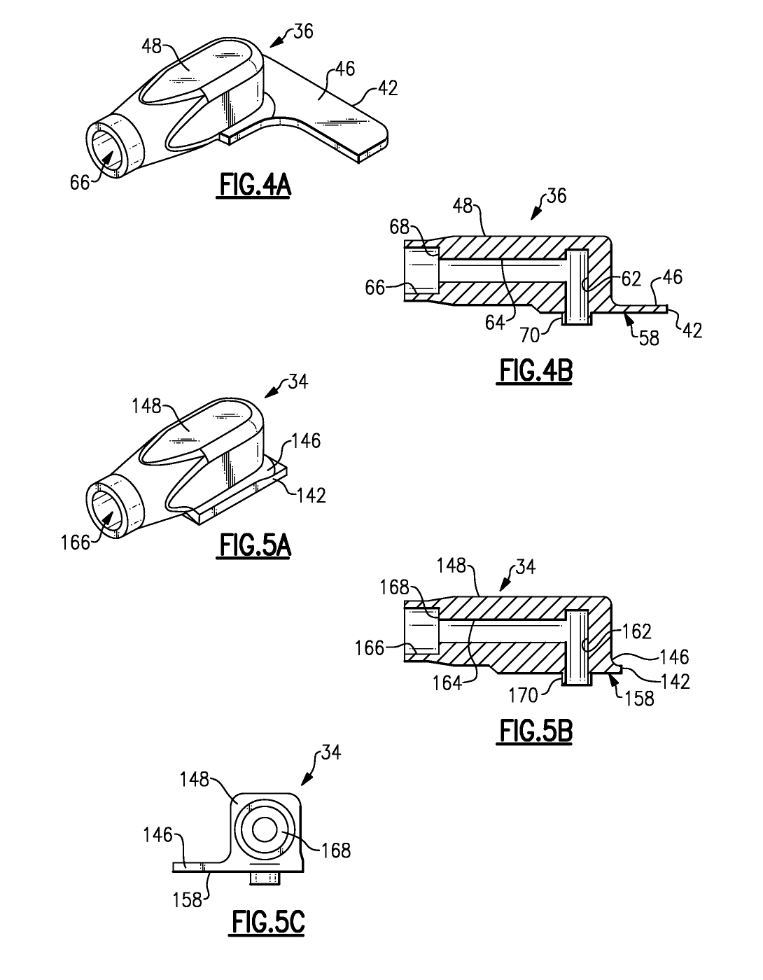

Referring to FIGS. 4A-4B, the first fluid port 36 includes a body 48 providing first and second fluid passage 62, 64 in fluid communication with one another. The flange 46 extends from and is integral with the body 48. In the example shown, the first and second fluid passages 62, 64 are transversely arranged relative to one another. The second passage 64 includes an opening 66 providing a shoulder 68 that receives an end of the system level tubing 40, for example. A protrusion 70 extends from the flange surface 58 to provide another locating feature, which will be discussed in further detail with respect to FIG. 6.

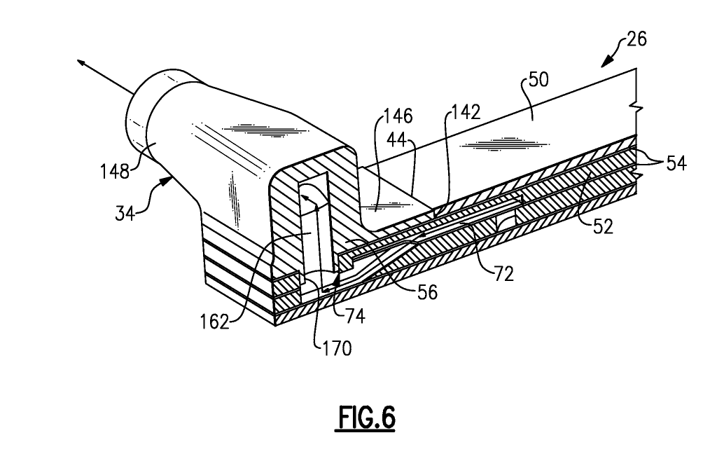

The second fluid port 34 is illustrated in more detail in FIGS. 5A-5C. The second fluid port 34 is of a similar configuration to that of the first fluid port 36. In the example, the flange 146 of the second fluid port 34 is of a different shape than that of the flange 46 of the first fluid port 36. At least a portion of peripheries 42, 142 (FIG. 4) abut one another in the example to laterally locate one another. The second fluid port 34 includes a body 148 providing first and second fluid passage 162, 164 in fluid communication with one another. In the example shown, the first and second fluid passages 162, 164 are transversely arranged relative to one another. The second fluid passage 164 includes an opening 166 providing a shoulder 168 that receives an end of the system level tubing 40, for example.

The second fluid port 34 is shown secured to the second sheet 52 of the cold plate 26 in FIG. 6. The protrusion 170 is received in an aperture or hole 74 in the second sheet 52. The passages of the second fluid port 34 are in fluid communication with the hole 74 and the cold plate passage 72 to communicate fluid from the fluid system 38 via the system level tubing 40 to the cold plate 26.

During manufacturing, a load is placed on the individually stacked components prior to the assembly entering the braze furnace to ensure close contact between the individual components and the braze alloy that exist between them. Various methods can be used to apply this load. For example, springs may be used to supply this load or, in another example, weights may be used to provide this load. In this latter case, one or more weights can be applied to the ports during brazing, and those weights may be independently configured relative to loads applied to other areas of the cold plate. This load is applied throughout the thermal brazing cycle and removed when the assembly is taken out of the furnace. The resulting procedure creates a monolithic brazed assembly.

Although an example embodiment has been disclosed, a worker of ordinary skill in this art would recognize that certain modifications would come within the scope of the claims. For that reason, the following claims should be studied to determine their true scope and content.

What is claimed is:

1. A cold plate assembly comprising:
a sheet having an aperture; and
a fluid port including a body having passage, and a flange extending from the body and secured to the sheet with a material, the passage and aperture in fluid communication with one another.

2. The cold plate assembly according to claim 1, wherein the sheet provides a planar surface, and the fluid port is arranged on the planar surface, the flange generally parallel to the planar surface.

3. The cold plate assembly according to claim 1, wherein the flange and the body are integral with one another forming a unitary structure.

4. The cold plate assembly according to claim 3, wherein the passage includes first and second passages arranged transverse to one another.

5. The cold plate assembly according to claim 1, wherein the fluid port includes a locating feature cooperating with the sheet and configured to locate the fluid port in a desired position relative to the sheet.

6. The cold plate assembly according to claim 5, wherein the locating feature is a protrusion extending from the flange in a direction opposite the body, the protrusion received within the aperture.

7. The cold plate assembly according to claim 5, wherein the locating feature is provided by a periphery of the flange, and comprising a second sheet secured to the sheet and including an edge abutting at least a portion of the periphery.

8. The cold plate assembly according to claim 1, wherein the material is a brazing material.

9. The cold plate assembly according to claim 1, comprising a second sheet secured to the sheet with a braze material, and the material is the braze material.

10. The cold plate assembly according to claim 1, comprising a tube secured to the body and in fluid communication with the passage.

11. A method of manufacturing a cold plate assembly comprising:
arranging multiple sheets relative to one another with a first material provided between the sheets;
arranging a fluid port on one of the multiple sheets with a passage of the fluid port in fluid communication with an aperture in at least one of the multiple sheets;
providing a second material between the fluid port and at least one of the multiple sheets; and
securing the fluid port and multiple sheets to one another with the first and second materials while loading the fluid port and the multiple sheets.

12. The method according to claim 11, wherein the first arranging step includes locating the sheets relative to one another within a form.

13. The method according to claim 11, wherein the second arranging step includes locating the fluid port relative to one of the multiple sheets with a locating feature.

14. The method according to claim 13, wherein the locating feature includes at least one of a fluid port flange perimeter and a protrusion extending from the fluid port and received within the aperture.

15. The method according to claim 11, wherein the first and second materials are the same.

16. The method according to claim 15, wherein the first and second materials are a brazing material, comprising the step of heating the first and second materials during the securing step.
